(19) United States
(12) Patent Application Publication
(10) Pub. No.: US 2025/0022431 A1
(43) Pub. Date: Jan. 16, 2025

(54) DRIVING METHOD FOR DISPLAY APPARATUS AND DISPLAY APPARATUS

(71) Applicant: HISENSE VISUAL TECHNOLOGY CO., LTD., Qingdao (CN)

(72) Inventors: Qiang DU, Qingdao (CN); Baogang LI, Qingdao (CN); Yuxin ZHANG, Qingdao (CN)

(21) Appl. No.: 18/900,766

(22) Filed: Sep. 29, 2024

Related U.S. Application Data
(63) Continuation of application No. PCT/CN2023/084608, filed on Mar. 29, 2023.

(30) Foreign Application Priority Data
Jun. 8, 2022 (CN) 202210641203.3
Jun. 14, 2022 (CN) 202210669073.4

(51) Int. Cl. G09G 3/34

(52) U.S. Cl. CPC G09G 3/3426; G09G 2320/0233; G09G 2330/023

(57) ABSTRACT

Disclosed are a driving method for a display device and the display device. In an image display process, when a brightness change is generated in a local area of a display image, a first brightness of a current display image is determined; a first driving current corresponding to the first brightness is determined according to the first brightness and the predetermined relationship between the brightness and a driving current; a duty ratio of the first driving current of each partition in a backlight module corresponding to areas other than the local area of the display image is adjusted; and a light source in each partition is driven by using the adjusted first driving current and duty ratio to emit light, such that the brightness of the display image in other areas is kept unchanged.

### CROSS-REFERENCES TO RELATED APPLICATIONS

The present application is a continuation application of PCT/CN2023/084608 filed on Mar. 29, 2023, which claims priority to the Chinese patent application No. 202210641203.3 filed on Jun. 8, 2022, and No. 202210669073.4 filed on Jun. 14, 2022, the entire contents of all of which are incorporated herein by reference.

### TECHNICAL FIELD

The present application relates to the field of display technology, and in particular, to a driving method for a display apparatus and a display apparatus.

### BACKGROUND

As the current mainstream display screen, the liquid crystal display screen has the advantages of low power consumption, small size, and low radiation. The liquid crystal display panel is a non-self-luminous panel and needs to be used with a backlight module.

The current direct-lit backlight module usually uses light-emitting diodes (LEDs for short) as backlight sources, which have the advantages of high backlight brightness and no decrease in brightness even after long-term use. Dividing the light sources in the backlight module into multiple partitions and combing it with regional dimming technology can achieve higher contrast and lower dark field brightness.

At present, when dimming the backlight, it is necessary to change the driving current for the entire backlight, which means that when a picture changes in brightness in a local region, the entire picture will also change in brightness due to the change of the driving current for the entire backlight, thereby affecting the display effect.

### SUMMARY

A driving method for a display apparatus according to an embodiment of the present application includes: during an image display process, when a display image changes in brightness in a local region, determining a first brightness of the display image; determining a first driving current corresponding to the first brightness based on the first brightness and a predetermined relationship between brightnesses and driving currents; adjusting a duty cycle of the first driving current for each partition, which corresponds to other region of the display image except the local region, in the backlight module; and driving light sources in each partition corresponding to the other region to emit light by using the first driving current with the adjusted duty cycle, to cause that the display image remains unchanged in brightness in the other region; wherein the first brightness is an average brightness of the display image after the display image changes in brightness in the local region.

A display apparatus according to an embodiment of the present application includes: a display panel, configured for image display; a backlight module, located on a light incident side of the display panel and configured to provide backlight; wherein the backlight module includes a plurality of light sources backlight value processing units. The plurality of light sources are divided into a plurality of partitions, each of the plurality of partitions includes at least one light source, and the at least one light source in a same one partition is connected in series. The backlight value processing units, electrically connected to the plurality of partitions and configured to provide driving signals to the plurality of partitions; wherein the backlight value processing units are configured to: during an image display process, when a display image changes in brightness in a local region, determine a first brightness of the display image; wherein the first brightness is an average brightness of the display image after the display image changes in brightness in the local region; determine a first driving current corresponding to the first brightness based on the first brightness and a predetermined relationship between brightnesses and driving currents; adjust a duty cycle of the first driving current for each partition, which corresponds to other region of the display image except the local region, in the backlight module; and drive light sources in each partition to emit light by using the first driving current with the adjusted duty cycle, to cause that the display image remains unchanged in brightness in the other region.

### BRIEF DESCRIPTION OF FIGURES

FIG. 1 is a first schematic cross-sectional structural schematic diagram of a display apparatus according to embodiments of the present application.

FIG. 2 is a first flowchart of a driving method for a display apparatus according to embodiments of the present application.

FIG. 3 is a relationship curve between driving currents and relative brightnesses according to embodiments of the present application.

FIG. 4 is a relationship curve between driving currents and driving voltages according to embodiments of the present application.

FIG. 5 is a second flowchart of a driving method for a display apparatus according to embodiments of the present application.

FIG. 6 is a first schematic diagram of a display image according to embodiments of the present application.

FIG. 7 is a second schematic diagram of a display image according to embodiments of the present application.

FIG. 8 is a third schematic diagram of a display image according to embodiments of the present application.

FIG. 9 is a fourth schematic diagram of a display image according to embodiments of the present application.

FIG. 10 is a perspective schematic diagram of a display apparatus according to embodiments of the present application.

FIG. 11 is a schematic top structural schematic diagram of a light panel according to embodiments of the present application.

FIG. 12 is a schematic cross-sectional structural schematic diagram of a light panel according to embodiments of the present application.

FIG. 13 is a schematic diagram of an operation scenario between a display apparatus and a control device according to embodiments of the present application.

FIG. 14 is a configuration block diagram of a control device according to embodiments of the present application.

FIG. 15 is a hardware configuration block diagram of a display apparatus according to embodiments of the present application.

FIG. 16 is a software configuration schematic diagram of a display apparatus according to embodiments of the present application.

FIG. 17 is a schematic diagram of displaying an icon control interface of an application in a display apparatus according to embodiments of the present application.

FIG. 18 is a second structural schematic diagram of a display apparatus according to embodiments of the present application.

FIG. 19 is a third flowchart of a driving method for a display apparatus according to embodiments of the present application.

FIG. 20 is a schematic diagram of displaying partition backlight values of a backlight module according to embodiments of the present application.

FIG. 21 is a schematic diagram of a backlight gain curve according to embodiments of the present application.

FIG. 22 is a fourth flowchart of a driving method for a display apparatus according to embodiments of the present application.

### DETAILED DESCRIPTION

In order to make the above objects, features and advantages of the present application more obvious and understandable, the present application will be further described below in conjunction with the accompanying drawings and embodiments. Example embodiments may, however, be embodied in various forms and should not be construed as limited to the embodiments set forth herein; rather, these embodiments are provided so that this disclosure will be thorough and complete, and will fully convey the concepts of the example embodiments to those skilled in the art. The same reference numerals in the drawings represent the same or similar structures, and thus repeated description of which will be omitted. The words expressing position and direction described in the present application are all explained by taking the accompanying drawings as examples, but they can be changed as needed, and all changes are included in the protection scope of the present application. The drawings in the present application are only used to illustrate relative positional relationships and do not represent true proportions.

The term “module”, as used in the present application, means any known or later developed hardware, software, firmware, artificial intelligence, fuzzy logic or combination of hardware and/or software code capable of performing the function associated with that component.

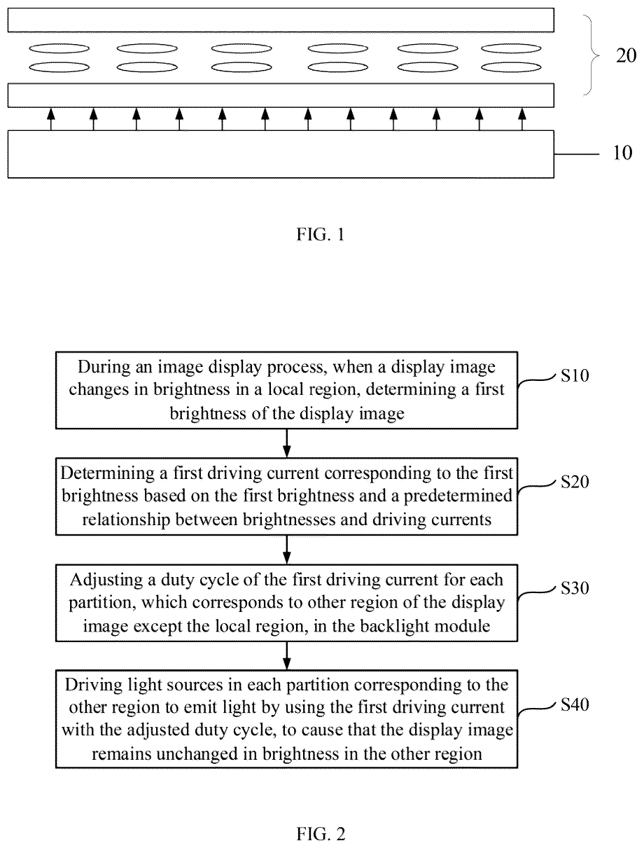

FIG. 1 is a first schematic cross-sectional structural schematic diagram of a display apparatus according to embodiments of the present application.

As shown in FIG. 1, the display apparatus includes: a backlight module 10 and a display panel 20.

The display panel 20 is located on a light emergent side of the backlight module 10 and is used for image display. The shape and size of the display panel 20 are adapted to the shape and size of the display apparatus. When applied to fields such as televisions or mobile terminals, the display panel 20 can be set in a rectangular shape, including a height side, a bottom side, a left side, and a right side, where the height side and the bottom side are opposite, and the left side and the right side are opposite. The height side is connected with one end of the left side and one end of the right side, the bottom side is connected to the other end of the left side and the other end of the right side. When applied to a special-shaped display apparatus, the display panel 20 may also adopt a circular shape or other shapes, which is not limited here.

The display panel 20 is a transmissive display panel that can modulate the transmittance of light but does not emit light itself. The display panel 20 has a plurality of pixel units arranged in an array. Each pixel unit can independently control the transmittance and color of the light incident on the pixel unit by the backlight module 10, so that the light transmitted through all the pixel units constitutes a display image. In specific implementation, the display panel 20 may be a liquid crystal display panel. In the liquid crystal display panel, the liquid crystal is placed between two sheets of conductive glass, and the electric field effect is caused by the distortion of the liquid crystal molecules driven by the electric field between the two electrodes to achieve the function of transmitting or blocking the light emitted by the backlight source, thereby displaying the image. If a color filter is added, a color image can be displayed.

The backlight module 10 can be a direct-lit backlight module or an edge-type backlight module. Compared with the edge-type backlight module, the direct-lit backlight module can be equipped with a larger number of light sources, thereby improving the backlight brightness. The direct-lit backlight modules usually use a light panel(s) or light bar(s) as a backlight source. Multiple light sources are arranged in an array on the light panel. The light bar is strip-shaped, and the light sources on which are arranged in a row. The light source can be a light-emitting diode (LED for short), a mini light-emitting diode (Mini LED for short) or even a micro light-emitting diode (Micro LED for short). LED has the advantages of high brightness, low energy consumption, and environmental protection. Mini LED and Micro LED are specifically LED chips, and their sizes are much smaller than LED. The size of Micro LED is smaller than the size of Mini LED. The size of Mini LED is less than 500 μm, usually less than 200 μm, and the size of Micro LED is less than 100 μm. When the light source uses Mini LED and Micro LED, a larger number of light sources can be installed on the light panels with the same area.

In order to improve the contrast of the display image, obtain lower dark field brightness, and achieve high dynamic range image display, the technology of local dimming (LD for short) for the backlight module according to the display image came into being. The light sources on the backlight module are divided into multiple partitions. When displaying an image, the brightness of each partition of the backlight module is adjusted accordingly according to the brightness distribution of the display image, so as to obtain a higher image contrast, and optimize the display effect. The greater the number of partitions is, the higher the level of regional dimming is, and the more delicate the display image is.

The dimming technology is mainly divided into analog dimming and digital dimming. For analog dimming, the brightness of the light source is adjusted by changing the current value of the light source. For digital dimming, the on and off time durations of the current of the light source are adjusted, that is, the pulse width modulation (PWM for short) is used to adjust the brightness of the light source. At present, the analog dimming is generally used in the display apparatus. When adjusting the brightness of the light sources, it can only change the current of the entire backlight module, causing the overall brightness of the display image to change. Moreover, the current driver chip has the shortcoming of insufficient current adjustment accuracy. The minimum adjustment range of the current is about 0.5 mA to 1 mA, and the light source variation range is 10 nit to 30 nit. This means that when the image changes in brightness in a local region, the brightness of the entire picture will also change due to the change in the driving current for the entire backlight, thereby affecting the display effect.

In view of this, embodiments of the present application provide a driving method for a display apparatus, which adopts analog and digital hybrid dimming technology. When the display image changes in brightness in a local region, the display image remains unchanged in brightness in other region(s) except the local region, thereby achieving the better image display effect.

FIG. 2 is a first flowchart of a driving method for a display apparatus according to an embodiment of the present application.

As shown in FIG. 2, a driving method for a display apparatus according to embodiments of the present application includes: S10, during an image display process, when a display image changes in brightness in a local region, determining a first brightness of the display image; S20, determining a first driving current corresponding to the first brightness based on the first brightness and a predetermined relationship between brightnesses and driving currents; S30, adjusting a duty cycle of the first driving current for each partition, which corresponds to other region of the display image except the local region, in the backlight module; and S40, driving light sources in each partition corresponding to the other region to emit light by using the first driving current with the adjusted duty cycle, to cause that the display image remains unchanged in brightness in the other region.

The first brightness is an average brightness of the display image after the display image changes in brightness in the local region. It should be noted that in the embodiments of the present application, the average brightness of the display image may refer to the average picture level (APL) of the display image. For example, the brightness gray scale of the display image can be 0 to 255, and the APL can also be 0 to 255 accordingly.

The display image changing in brightness in the local region may be caused by the change in image content during the image display process, which causes the image frame currently displayed to have brightness change in the local region relative to the previous image frame. In related art, if the display image changes in brightness in the local region, the analog dimming is usually used to change the driving current for the backlight module accordingly, so that the brightness of the entire backlight module changes accordingly, and the brightness of the entire display image also changes accordingly.

In the embodiments of the present application, the analog and digital hybrid dimming technology is used to compensate for the duty cycles of the driving currents corresponding to the partitions in other region(s) except the local region when the brightness changes in the local region of the display image, thereby making the brightness in other region(s) unchanged.

When the display image changes in brightness in the local region, an average brightness (i.e., the first brightness) of the display image after the brightness change can be determined first, and then the driving current corresponding to the first brightness is determined based on the known correspondence relationship between brightnesses and driving currents. After the driving current is determined, the duty cycle of the driving current for each partition of the backlight module corresponding to other region(s) except the local region where the brightness changes is correspondingly compensated, so that when the driving current with the adjusted duty cycle is used to drive the light sources in other region(s) except the local region to emit light, the display image does not change in brightness in other region(s) except the local region, thereby achieving the better display effect.

In the display apparatus according to the embodiments of the present application, a light-emitting diode device is used as the backlight source, and the light emitted from the backlight module provides backlight for the display panel. The average brightness of the above-mentioned display image refers to the average brightness of the display image after the backlight is modulated by the display panel. Therefore, the average brightness of the display image is not equal to the average brightness of the backlight module, but there is a positive correlation between them, that is, the higher the brightness of the display image is, the higher the brightness of the backlight module is; and the lower the brightness of the display image is, the lower the brightness of the backlight module is.

Light-emitting diodes are current-type driving devices. When the display image changes in brightness in the local region, in order to achieve the better display effect, the backlight module is usually adjusted in brightness accordingly to match the change in brightness of the display image. At this time, it is necessary to adjust the driving current for the light-emitting diode. In the embodiments of the present application, when the brightness of the display image changes, the driving current value of the backlight module needs to be changed, so that the brightness change trend of the backlight module is consistent with the brightness change trend of the display image. This process is the above-mentioned analog dimming. At the same time, it is also necessary to compensate for the duty cycles of the driving currents of the backlight module corresponding to the position of other region(s) except the local region. This process is the above-mentioned digital dimming, so that the backlight brightness in other region(s) does not change with the change of the backlight brightness in the local region.

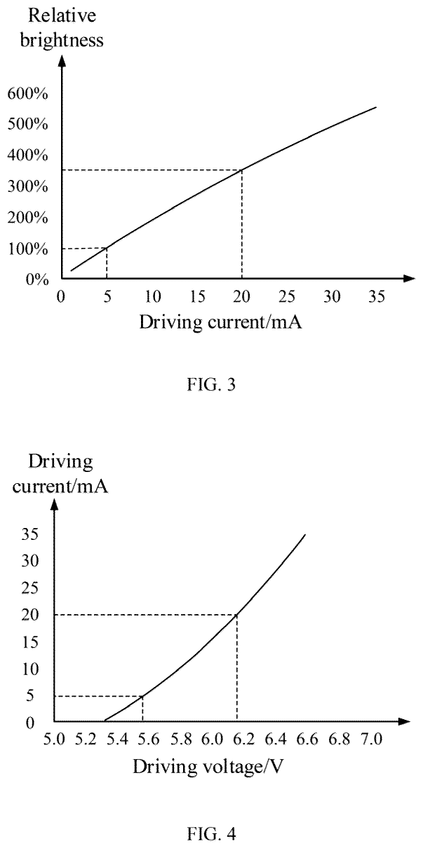

FIG. 3 is a relationship curve between driving currents and relative brightnesses according to embodiments of the present application.

As shown in FIG. 3, when the display apparatus leaves the factory, the relationship between driving currents and relative brightnesses is determined. The corresponding relationship is solidified in the program of the display apparatus. When displaying an image, the driving current can be automatically determined based on the brightness to drive the backlight module. In the embodiments of the present application, when the average brightness of the display image is known, the driving current for the backlight module can be determined according to the relationship curve between driving currents and relative brightnesses shown in FIG. 3. In actual application, the known relationship curve between driving currents and relative brightnesses of the display apparatus may be different from that shown in FIG. 3. The relationship curve shown in FIG. 3 is only taken as an example and the relationship between driving currents and relative brightnesses is not limited in the embodiments of the present application.

It can be seen from FIG. 3 that the driving current for the backlight module is positively correlated with the relative brightness of the display image. The relative brightness has a certain corresponding relationship with the average brightness of the display image. When the display image is at different average brightnesses, the driving currents of the backlight module can be determined according to the curve of driving currents and relative brightnesses.

For example, when the backlight module is driven by using the driving current of 5 mA, the relative brightness achieved is 100%; and when the backlight module is driven by using the driving current of 20 mA, the relative brightness achieved is 350%.

FIG. 4 is a relationship curve between driving currents and driving voltages according to embodiments of the present application.

It can be seen from FIG. 4 that there is a positive correlation between the driving current and the driving voltage of the backlight module. For example, when the driving current is 5 mA, the driving voltage is 5.55 V; and when the driving current is 20 mA, the driving voltage is 6.15 V. Then there is also a positive correlation between the power and the driving current for the backlight module.

If we take the scenario of displaying a full white image as an example, when the backlight module is driven to emit light by using the driving current of 5 mA and the duty cycle of 100%, and by using the driving current of 20 mA and the duty cycle of 25%, due to the effective current values the two are all 5 mA, the theoretically achieved effects are consistent.

According to the relationship curve between driving currents and relative brightnesses shown in FIG. 3, it can be seen that a driving current of 5 mA corresponds to a relative brightness of 100%, and a driving current of 20 mA corresponds to a relative brightness of 350%. The driving current for the backlight module increases from 5 mA to 20 mA, and the relative brightness of the backlight module increases from 100% to 350%. That is, the driving current increases by 4 times, but the relative brightness only increases by 3.5 times. That is to say, the luminous efficiency is improved by (4-3.5)/4=12.5% when using the driving current of 5 mA compared to using the driving current of 20 mA.

According to the relationship curve between driving currents and driving voltages shown in FIG. 4, it can be seen that a driving current of 5 mA corresponds to a driving voltage of 5.55 V, and the power is 5 mA×5.55 V=27.75 mW; and a driving current of 20 mA corresponds to a driving voltage of 6.15 V, and the power is 20 mA×6.15 V=123 mW. The driving current for the backlight module increases from 5 mA to 20 mA, and the power increases from 27.75 mW to 123 mW. That is, the driving current increases by 4 times and the power increases by 4.43 times. That is to say, the power is reduced by (4.43−4)/4.43=9.7% when using the driving current of 5 mA compared to using the driving current of 20 mA.

Then, on the premise that the luminous effects are consistent, the driving current with the current value of 5 mA and the duty cycle of 100% compared to the driving current with the current value of 20 mA and the duty cycle of 25% to drive the backlight module, the luminous efficiency is improved by 14%, the power is reduced by 9.7%. Therefore, in a scenario where the driving current changes from large to small in the embodiments of the present application, the luminous efficiency can be improved and the power consumption can be reduced.

If the driving current for the backlight module before the display image changes in brightness in the local region is called a second driving current, and the driving current for the backlight module after the display image changes in brightness in the local region is called the first driving current, then the driving method provided by the embodiments of the present application is particularly suitable for application scenarios in which the first driving current is smaller than the second driving current.

In practical applications, in order to ensure that the power of the backlight module does not exceed the maximum power, when the APL of the display image is larger, the backlight module is driven by a smaller driving current; and when the APL of the display image is smaller, the backlight module is driven by a larger driving current.

In the embodiment of the present application, a method for compensating the duty cycle of the driving current to cause that the display image remains unchanged in brightness in other region(s) in addition to the display image changing in brightness in the local region.

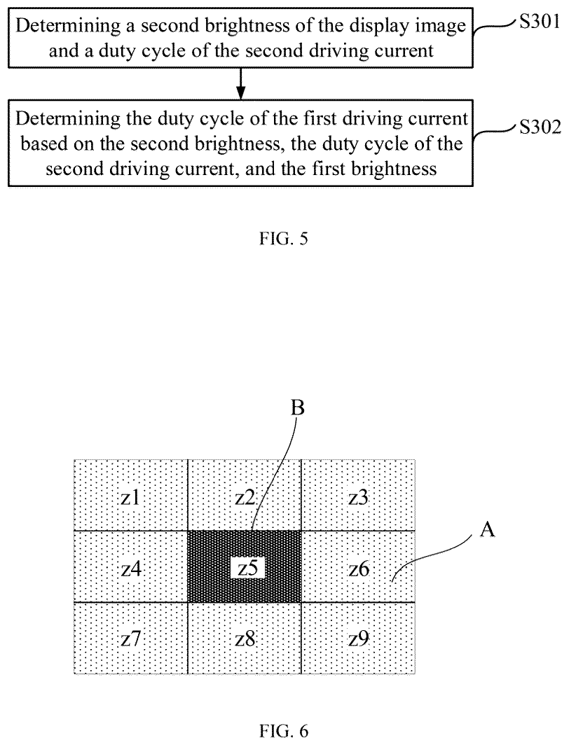

FIG. 5 is a second flowchart of a driving method for a display apparatus according to embodiments of the present application.

As shown in FIG. 5, in the above-mentioned step S30, adjusting a duty cycle of the first driving current for each partition, which corresponds to other region of the display image except the local region, in the backlight module, including: S301, determining a second brightness of the display image and a duty cycle of the second driving current; and S302, determining the duty cycle of the first driving current based on the second brightness, the duty cycle of the second driving current, and the first brightness.

The second brightness is an average brightness of the display image before the display image changes in brightness in the local region, and the second driving current is a driving current corresponding to the second brightness.

In the embodiments of the present application, in order to remain the backlight brightness unchanged in other region(s) except the local region where the brightness changes, the luminous brightness is not only directly related to the current value of the driving current, but also related to the duty cycle of the driving current. When the brightness of the display image changes, the driving current value has been determined according to the corresponding relationship between brightnesses and driving currents. Therefore, in the embodiments of the present application, the brightness is adjusted by adjusting the duty cycle of the driving current in other region(s).

Specifically, in the embodiments of the present application, the duty cycle of the driving current corresponding to the other region(s) except the local region after the display image changes in brightness in the local region is determined based on the average brightnesses of the display image before and after the display image changes in brightness in the local region, and the duty cycle of the driving current for the backlight module before the display image changes in brightness in the local region.

In order to easily distinguish between the driving currents before and after the brightness change and distinguish between the brightnesses corresponding to the driving currents before and after the brightness change, in the embodiments of the present application, the average brightness after the display image changes in brightness in the local region is called the first brightness, and the driving current corresponding to the first brightness is called the first driving current; the average brightness before the display image changes in brightness in the local region is called the second brightness, and the driving current corresponding to the second brightness is called the second driving current.

In the embodiments of the present application, the duty cycle of the first driving current can be determined by using the following formula: D₁=D₂ (L₂/L₁).

Among them, D₁ represents the duty cycle of the first driving current, D₂ represents the duty cycle of the second driving current, L₁ represents the first brightness, and L₂ represents the second brightness.

In specific implementation, the current display image is an image after the local change in brightness of the previous frame display image. Then the average brightness (L₂) and the duty cycle (D₂) of the driving current for the previous frame display image are known parameters. In a condition that the driving current is determined, the average brightness (L₁) of the current display image can be obtained according to the corresponding relationship between driving currents and relative brightnesses shown in FIG. 3. Therefore, in a condition that L₁, L₂ and D₂ are known, based on the above, the duty cycle (D₁) of the driving current for the current display image can be calculated.

For example, assuming that before the brightness changes in the local region, the driving current for the backlight module is 20 mA (i.e., the second driving current is 20 mA), and the duty cycle is 25% (i.e., D₂=25%), the relative brightness of the corresponding display image is 350%; after the brightness changes in the local region of the display image, the driving current for the backlight module is 5 mA (that is, the first driving current is 5 mA), and the relative brightness of the corresponding display image is 100%. According to the above formula, it can be calculated that in the other region(s) except the local region where the brightness changes, the duty cycle of the driving current D₁=350%×25%/100%=87.5%.

Since the relationship between driving currents and luminous brightnesses of the backlight module is not linear but the luminous efficiency is higher when the driving current is smaller, when the driving current for the backlight module changes from large to small, the luminous efficiency can be improved and the power consumption can be reduced.

In the above step S301, when determining the average brightness of the display image, the average value of brightnesses of the display image in the partitions may be used as the average brightness of the display image.

In specific implementation, the brightnesses of the partitions in the backlight module are determined according to the brightness distribution of the display image. Therefore, when the display image is divided according to the partitions corresponding to the backlight module, the average value of the brightnesses of the display image in the partitions is the above-mentioned average brightness.

For example, the light sources in the backlight module are divided into four partitions: z₁, Z₂, Z₃, and z₄. The brightness of the display image corresponding to the region where the first partition z₁ is located is l₁, and the brightness of the display image corresponding to the region where the second partition z₂ is located is l₂, the brightness of the display image corresponding to the region where partition z₃ is located is l₃, and the brightness of the display image corresponding to the region where partition z₄ is located is l₄. Then, in this way, the average brightness of the display image is L=(l₁+l₂+l₃+l₄)/4.

In practical applications, before the brightness in the local region of the display image changes, the average brightness of the display image and the duty cycle of the driving current are both known quantities. Therefore, the current driving current and the duty cycle of the driving current can be determined based on the brightness of the to-be-displayed image after the display image changes in brightness in the local region.

For the local region where the brightness changes, a ratio of a brightness of a partial image of the display image corresponding to a certain partition to the maximum brightness can be used as the duty cycle of the first driving current for the partition.

For example, the light sources in the backlight module are divided into four partitions z₁ to z₄. If the brightness of the display image in the region where partition z₁ is located becomes gray scale 100 and the maximum gray scale is 255, then the duty cycle of the driving current in driving partition z₁ is (100/255)×100%≠39.2%. The duty cycles of the driving currents for other partitions where the brightness changes can be determined according to the above method.

Since the light sources of the backlight module are divided into multiple partitions, the local region where the brightness of the display image changes may correspond to more than one partition of the backlight module. Similarly, the region(s) other than the local region may also correspond to multiple partitions of the backlight module. Then, the driving current and the duty cycle of the driving current in each partition in the backlight module can be determined according to the above method. After determining the driving currents and the duty cycles of the driving currents of all partitions, the same driving current and the duty cycle corresponding to the partition is used to drive the light sources in each partition to emit light.

The digital and analog hybrid dimming method of the present application will be specifically described below with two examples.

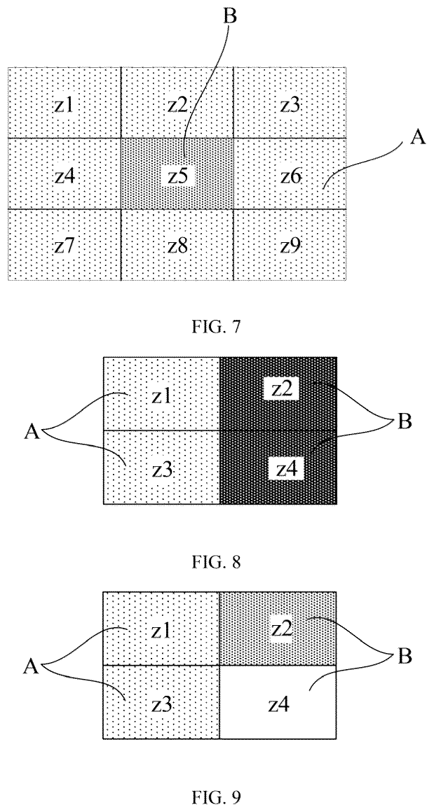

FIG. 6 is a first schematic diagram of a display image according to embodiments of the present application. FIG. 7 is a second schematic diagram of a display image according to embodiments of the present application. Among them, FIG. 6 is a display image before the brightness of the display image changes, and FIG. 7 is a display image after the brightness changes in the region B.

When the display image changes from FIG. 6 to FIG. 7, the brightness changes only in region B. In the display images shown in FIGS. 6 and 7, the region B represents the local region where the brightness changes, and the region A represents the region(s) other than the local region.

The light sources in the backlight module are divided into nine partitions z₁ to z₉. Correspondingly, the display image can also be regarded as divided into nine parts corresponding to z₁ to z₉, in which the region B corresponds to the partition z₅, the regions A corresponds to z₁ to z₄ and z₆ to z₉.

When the display image changes from FIG. 6 to FIG. 7, since only region B changes in brightness, in order to remain the brightness of the display image in region A unchanged and improve the contrast of the screen, the average brightness L₁ of the display image shown in FIG. 6, the average brightness L₂ of the display image shown in FIG. 7, and the driving current for the display image shown in FIG. 6 in the partitions z₁ to z₉ and the duty cycles D₂₁ to D₂₉ of the driving currents need to be determined, and thus when the display image changes to FIG. 7, the driving currents in the partitions z₁ to z₉ and their duty cycles Du to D₁₉ are determined.

Among them, before the brightness changes in the region B of the display image (as shown in FIG. 6), the average brightness L₂ of the display image is the average brightness of partial display images corresponding to the partitions z₁ to z₉. The average brightness L₂ and driving current values I₂ of the partitions z₁ to z₉ and the duty cycles D₂₁ to D₂₉ of the driving currents of the partitions z₁ to z₉ are all known parameters. After the change in the region B of the display image (as shown in FIG. 7), for the brightness inputs of partial display images corresponding to partitions z₁ to z₉, the average brightness L₁ of the display image is the average value of the brightnesses of the partial display images corresponding to partitions z₁ to z₉. The driving current I₁ of the backlight module can be determined based on the corresponding relationship between driving currents and brightnesses shown in FIG. 3. The driving currents of the backlight module for partitions z₁ to z₉ are all I₁, but the duty cycles of the driving currents of the partitions needs to be adjusted, so that the display image remains the original brightness in the region A after the display image changes in brightness in region B.

For the partitions 21 to 24 and 26 to z₉, the manners for determining the duty cycles of the driving currents of the partitions are the same. The partition 21 used as an example for illustration. When displaying the image shown in FIG. 6, the average brightness of the display image is L₂, the driving current for each partition is I₂, and the duty cycle of the driving current for partition z₁ is D₂₁. Since the image shown in FIG. 6 is an image that has been displayed before it changes to the image in FIG. 7, so L₂, I₂, and D₂₁ are all known parameters. When the display image shown in FIG. 6 changes to the display image shown in FIG. 7, the brightnesses of the partial display images corresponding to the partitions are input, so that the average brightness L₁ of the display image shown in FIG. 7 can be obtained, and then the driving current for the backlight module is determined to be I₁ based on the average brightness L₁ and the relationship curve shown in FIG. 3. Therefore, the duty cycle of the driving current for partition z₁ can be calculated as D₁₁=D₂₁ (L₂/L₁) based on the above formula. The same manner can be used to calculate the duty cycles D₁₂ to D₁₄ and D₁₆ to D₁₉ of the driving currents of the partitions z₂ to z₄ and z₆ to z₉.

For partition z₅, the duty cycle Dis of the driving current for this partition can be determined based on the ratio of the brightness of the partial display image corresponding to partition z₅ to the maximum brightness.

From this, the driving current I₁ of the backlight module when displaying the image shown in FIG. 7 and the duty cycles Du to D₁₉ of the driving currents of partitions z₁ to z₉ can be obtained. Then, when displaying the image shown in FIG. 7, the driving current I₁ is used in the backlight module, and the duty cycles of the driving current for partitions are D₁₁ to D₁₉ respectively, so that the display image in region B reaches the corresponding brightness, while the display brightness in region A remains unchanged.

FIG. 8 is a third schematic diagram of a display image according to embodiments of the present application. FIG. 9 is a fourth schematic diagram of a display image according to embodiments of the present application. Among them, FIG. 8 is a display image before the brightness of the display image changes, and FIG. 9 is a display image after the brightness changes in the region B.

When the display image changes from FIG. 8 to FIG. 9, the brightness changes only in region B. In the display images shown in FIGS. 8 and 9, the region B represents the local region where the brightness changes, and the region A represents the region(s) other than the local region.

The light sources in the backlight module are divided into four partitions z₁ to z₄. Correspondingly, the display image can also be regarded as divided into four parts corresponding to z₁ to z₄, in which the region B corresponds to the partitions z₂ and z₄, and the region A corresponds to z₁ and z₃.

Before the display image changes from FIG. 8 to FIG. 9, the display image shown in FIG. 8 is an image that has already been displayed. Therefore, the average brightness L₂ of the display image, the driving currents I₂ of the backlight module, and the duty cycles D₂₁ to D₂₄ of the driving currents of partitions z₁ to z₄ are known parameters.

When the display image changes from FIG. 8 to FIG. 9, the brightnesses of portions of the display image corresponding to the partitions z₂ and z₄ changes, and the brightnesses corresponding to the partitions z₂ and z₄ changes in different degrees. When the display image changes from FIG. 8 to FIG. 9, the brightnesses of the display image corresponding to the partitions z₁ to z₄ are l₁₁, l₁₂, l₁₃, l₁₄, respectively. Then after the brightness changes, the average brightness of the display image L₁=(l₁₁+l₁₂+l₁₃+l₁₄)/4. The driving current for the backlight module can be determined to be I₁ based on the relationship curve shown in FIG. 3.

The duty cycle D₁₂ of the driving current for partition z₂ can be calculated based on the ratio of the brightness of partition z₂ to the maximum brightness. The duty cycle D₁₄ of the driving current for partition z₄ can be calculated based on the ratio of the brightness of partition z₄ to the maximum brightness. The duty cycle of the driving current for partition z₁ can be obtained as D₁₁=D₂₁ (L₂/L₁) according to the above formula. The duty cycle of the driving current for partition z₃ can be obtained as D₁₃=D₂₃ (L₂/L₁) according to the above formula.

From this, the driving current for the backlight module and the duty cycle of the driving current for each partition can be determined when the display image changes from FIG. 8 to FIG. 9. Then, the light sources in each partition are driven by the determined driving current and its duty cycle, which can make the brightness of region A remain unchanged when the brightness of region B changes.

In the embodiments of the present application, the number of partitions of the backlight module is nine or four are only used as examples for illustration, and the number of partitions included in the backlight module are not limited. In practical applications, the driving current and the duty cycle of the backlight module can be adjusted according to the above principles to optimize the image display effect.

The display apparatus is provided embodiments of the present application. FIG. 1 is the schematic cross-sectional structural schematic diagram of the display apparatus according to embodiments of the present application.

As shown in FIG. 1, the display apparatus includes: a backlight module 10 and a display panel 20. The display panel 20 is located on the light emergent side of the backlight module 10. The backlight module 10 is used to provide backlight, and the display panel 20 is used for display images.

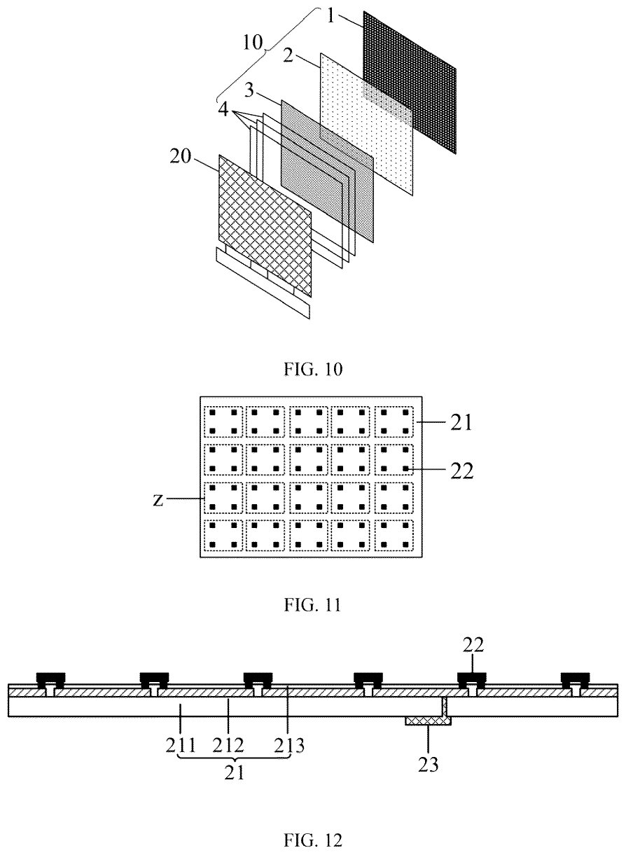

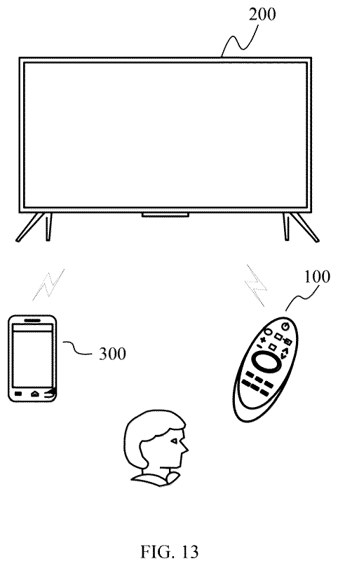

FIG. 10 is a perspective schematic diagram of a display apparatus according to embodiments of the present application.

As shown in FIG. 10, the backlight module includes: a backplane 1, a backlight source 2, a diffusion plate 3 and an optical film 4.

The backplane 1 is located at the bottom of the backlight module and plays a supporting and carrying role. The backplane 1 is usually provided with a square structure, and when applied to a special-shaped display apparatus, the shape of the backplane is adapted to the shape of the display apparatus. The backplane 1 includes a height side, a bottom side, a left side, and a right side, where the height side and the bottom side are opposite, and the left side and the right side are opposite. The height side is connected with one end of the left side and one end of the right side, the bottom side is connected to the other end of the left side and the other end of the right side.

The material of the backplane 1 is aluminum, iron, aluminum alloy or iron alloy, etc. The backplane 1 is used to support the backlight source 2 and to support and fix the edges of components such as the diffusion plate 3 and the optical film 4, ect. The backplane 1 also plays a role in dissipating heat from the backlight source 2.

In the embodiments of the present application, the backlight module preferably adopts a direct-lit backlight module, so that more light sources can be provided and the backlight brightness can be improved.

In some embodiments, the backlight source 2 may be a light bar(s) or a light panel(s). In the embodiments of the present application, the backlight source 2 adopts a light panel as an example to describe its structure in detail.

The light panel(s) is located on the backplane 1. Typically, the overall light panel can be square or rectangular. Multiple light panels can be provided according to the size of the display apparatus, and the light panels are spliced together to provide backlight.

The diffusion plate 3 is located on the light emergent side of the backlight source 2 and is separated from the backlight source 2 by a certain distance. This distance is set to allow sufficient light mixing between the light sources. The diffusion plate 3 is provided a function of scattering the incident light to make the light passing through the diffusion plate 3 more uniform.

The diffusion plate 3 is provided with a scattering particle material. When light is incident on the scattering particle material, refraction and reflection will occur continuously, thereby achieving the effect of scattering the light and achieving uniform light effect. The thickness of the diffusion plate is usually set in a range of 0.5 mm to 3 mm. The thicker the diffusion plate is, the greater the haze and the better the uniform effect are.

The diffusion plate 3 can usually be processed by an extrusion process, and the material used for the diffusion plate 3 is generally selected from at least one of polymethyl methacrylate (PMMA), polycarbonate (PC), polystyrene-based material (PS), or polypropylene (PP).

In the embodiments of the present application, the backlight source 2 can be used to emit blue light. In this way, the diffusion plate 3 can be a quantum dot diffusion plate, and is used to achieve color conversion and diffusion function.

The optical film 4 is located on the side of the diffusion plate 3 away from the backlight source 2. The size of the optical film 4 is suitable for the display apparatus, is slightly smaller than the size of the display apparatus, and is usually set in a rectangular or square shape.

In specific implementation, the optical film 4 includes one or more of a fluorescent film, a quantum film, a prism film, or a brightness enhancement film, etc., which can be set according to specific needs and is not limited here.

FIG. 11 is a schematic top structural schematic diagram of a light panel according to embodiments of the present application, and FIG. 12 is a schematic cross-sectional structural schematic diagram of a light panel according to embodiments of the present application.

As shown in FIGS. 11 and 12, in the embodiments of the present application, when the backlight source 2 adopts a light panel, the backlight source includes a circuit board 21, light sources 22 and a backlight value processing unit 23.

The circuit board 21 is located on the backplane 1, and the shape of the circuit board 21 is the same as the overall shape of the light panel. Under normal circumstances, the circuit board 21 is plate-shaped and has a rectangular or square shape as a whole.

The circuit board 21 can usually be a printed circuit board (PCB for short). According to actual needs, the circuit board 21 can be a single-layer board, a double-layer board or a multi-layer board, which is not limited here.

As shown in FIG. 12, the circuit board 21 includes: a substrate 211, a line layer 212 and a solder resist layer 213.

The substrate 211 has a carrying function, has the same shape and size as the circuit board, and can usually be set in a rectangular or square shape. The substrate 211 can be made of BT, FR4, aluminum, glass or flexible materials, etc., and is selected according to the application scenario, which is not limited here.

The line layer 212 is located on the substrate and is used to transmit driving signals. The line layer 212 can usually be formed by covering the substrate 211 with copper and then patterning.

The solder resist layer 213 is located on the side of the line layer 212 away from the substrate 211 and is used to insulate and protect the line layer 212. The solder resist layer 213 is usually made of an insulating material that is coated on the surface of the line layer 212. The solder resist layer 213 includes a plurality of openings, and solder pads are exposed at the positions of the openings for soldering the light sources 22 and other components.

The light sources 22 are located on the circuit board 21, and are on the side of the solder resist layer 213 away from the line layer 212. The light sources 22 are electrically connected to the line layer 212 through the openings of the solder resist layer 213.

In the embodiments of the present application, the light sources 22 can be LEDs, Mini LEDs or Micro LEDs, which are not limited here.

The backlight value processing unit 23 can be bound to the side of the circuit board 21 away from the light sources 22, or can be bound to the side of the circuit board 21 close to the light sources 22, which is not limited here.

The backlight value processing unit 23 is used to provide a driving signal to the backlight module, thereby driving the light sources in the backlight module to emit light.

As shown in FIG. 11, multiple light sources 22 are divided into multiple partitions z, each partition z includes at least one light source 22, and the light sources 22 in the same partition z are connected in series with each other. The backlight value processing unit 23 is electrically connected to each partition z, and is used to provide driving signals to each partition Z.

In the embodiments of the present application, the backlight value processing unit may use a Micro LED driver chip. When the Micro LED driver chip provides driving signals to the backlight module, the driving current values of the partitions are consistent, but the duty cycles of the driving currents of the partitions are different, which results in different brightnesses of the partitions.

The backlight value processing unit 23 is configured to: during an image display process, when a display image changes in brightness in a local region, determine a first brightness of the display image; determine a first driving current corresponding to the first brightness based on the first brightness and a predetermined relationship between brightnesses and driving currents; adjust a duty cycle of the first driving current for each partition, which corresponds to other region(s) of the display image except the local region, in the backlight module; and drive light sources in each partition to emit light by using the first driving current with the adjusted duty cycle, to cause that the display image remains unchanged in brightness in the other region. The first brightness is an average brightness of the display image after the display image changes in brightness in the local region.

In the embodiments of the present application, the analog and digital hybrid dimming technology is used to compensate for the duty cycles of the driving currents corresponding to the partitions in other region(s) except the local region when the brightness changes in the local region of the display image, thereby making the brightness in other region(s) remain unchanged, improving the contrast of the display image, and optimizing the image display effect.

Among them, the backlight value processing unit 23 is configured to determine a second brightness of the display image and a duty cycle of the second driving current; and determine the duty cycle of the first driving current based on the second brightness, the duty cycle of the second driving current, and the first brightness. The second brightness is an average brightness of the display image before the display image changes in brightness in the local region, and the second driving current is a driving current corresponding to the second brightness.

The backlight value processing unit 23 determines the duty cycle of the first driving current by using the following formula: D₁=D₂ (L₂/L₁).

Among them, D₁ represents the duty cycle of the first driving current, D₂ represents the duty cycle of the second driving current, L₁ represents the first brightness, and L₂ represents the second brightness.

The duty cycle of the driving current for each partition corresponding to the local region where the brightness changes can be determined according to the ratio of the brightness of the partition to the maximum brightness. Therefore, when the determined driving current and the duty cycle of the driving current for each partition are used to drive the light sources of each partition to emit light, the display image can remain unchanged in brightness in other region(s) except for the local region where the brightness changes.

FIG. 13 is a schematic diagram of an operation scenario between a display apparatus and a control device according to embodiments of the present application. As shown in FIG. 13, the user can operate the display apparatus 200 through the mobile terminal 300 or the control device 100. The control device 100 may be a remote controller, and the communication between the remote controller and the display apparatus includes infrared protocol communication, Bluetooth protocol communication, and wireless or other wired manners for controlling the display apparatus 200. The user can control the display apparatus 200 by inputting user commands through buttons on the remote control, voice input, or control panel input, etc. In some embodiments, mobile terminals, tablets, computers, laptops, and other smart devices may also be used to control the display apparatus 200.

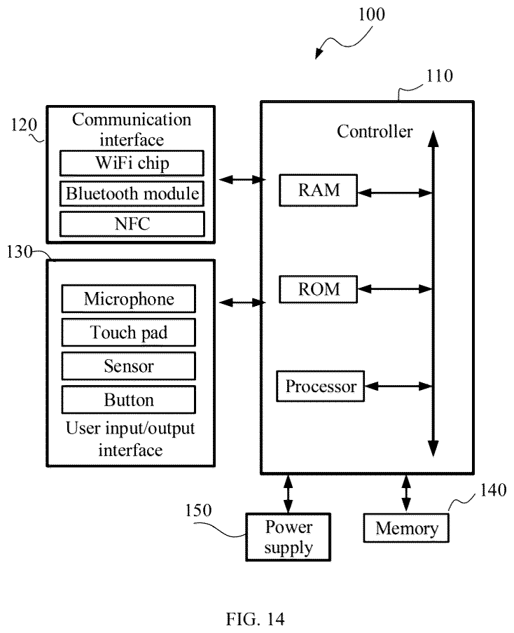

FIG. 14 is a configuration block diagram of a control device according to embodiments of the present application. As shown in FIG. 14, the control device 100 includes a controller 110, a communication interface 120, a user input/output interface 130, a memory 140, and a power supply 150. The control device 100 can receive input operation commands from the user, and convert the operation commands into commands that the display apparatus 200 can recognize and respond to, thereby acting an intermediary for the interaction between the user and the display apparatus 200. The communication interface 120 is used to communicate with the outside and includes at least one of a WIFI chip, a Bluetooth module, NFC or a replaceable module. The user input/output interface 130 includes at least one of a microphone, a touch pad, a sensor, a button, or a replaceable module.

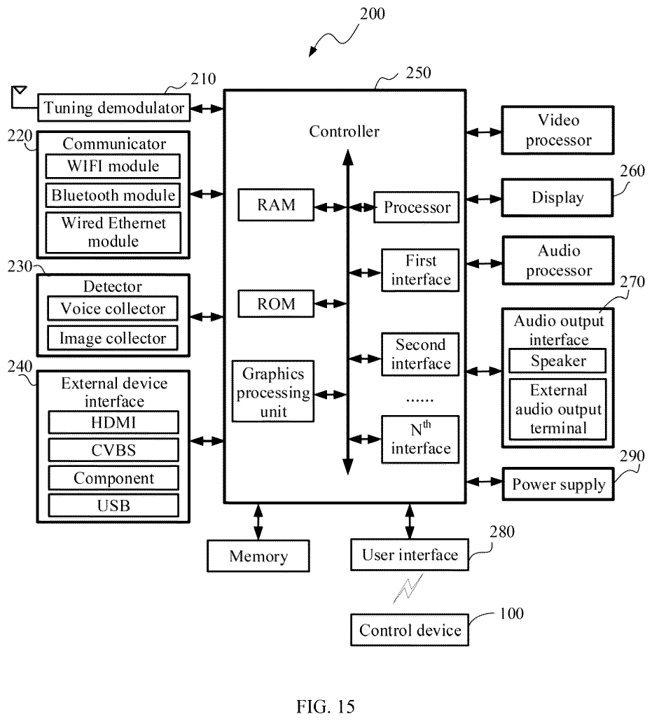

FIG. 15 is a hardware configuration block diagram of a display apparatus according to embodiments of the present application. As shown in FIG. 15, the display apparatus 200 includes at least one of a tuning demodulator 210, a communicator 220, a detector 230, an external device interface 240, a controller 250, a display 260, an audio output interface 270, a memory, a power supply 290, or a user interface 280. The controller 250 includes a central processing unit (CPU), a video processor, an audio processor, a graphics processing unit (GPU), a random access memory (RAM), a read-only memory (ROM), and 1^{st} to n^{th} interfaces for input/output. The display 260 may be at least one of a liquid crystal display, an organic light-emitting diode (OLED) display, a touch display, or a projection display, and may also be a projection device and a projection screen. The tuning demodulator 210 receives broadcast television signals through wired or wireless reception manners, and demodulates audio and video signals, such as electronic program guide (EPG) data signals, from multiple wireless or wired broadcast television signals. The detector 230 is used to collect signals from the external environment or signals interacting with the outside. The controller 250 and the tuning demodulator 210 may be located in different separate devices, that is, the tuning demodulator 210 may also be located in an external device, such as an external set-top box, of the main device where the controller 250 is located.

In some embodiments, the controller 250 controls the operation of the display apparatus and responds to user operations through various software control programs stored in the memory. The controller 250 controls the overall operation of the display apparatus 200. The user may input a user command into a graphical user interface (GUI) displayed on the display 260, and the user input interface receives the user input command through the graphical user interface (GUI). Alternatively, the user can input a user command by inputting a specific sound or gesture, and the user input interface recognizes the sound or gesture through the sensor to receive the user input command.

In some embodiments, the “user interface” is a media interface for interaction and information exchange between an application program or an operating system and a user, and implements conversion between the internal form of information and a form acceptable to the user. The commonly used form of user interface is GUI, which refers to a user interface related to computer operations that is displayed graphically. It can be an icon, window, control and other interface elements displayed on the display screen of an electronic device. Controls can include at least one of visual interface elements, such as an icon, a button, a menu, a tab, a text box, a dialog box, a status bar, a navigation bar, or a widget, etc.

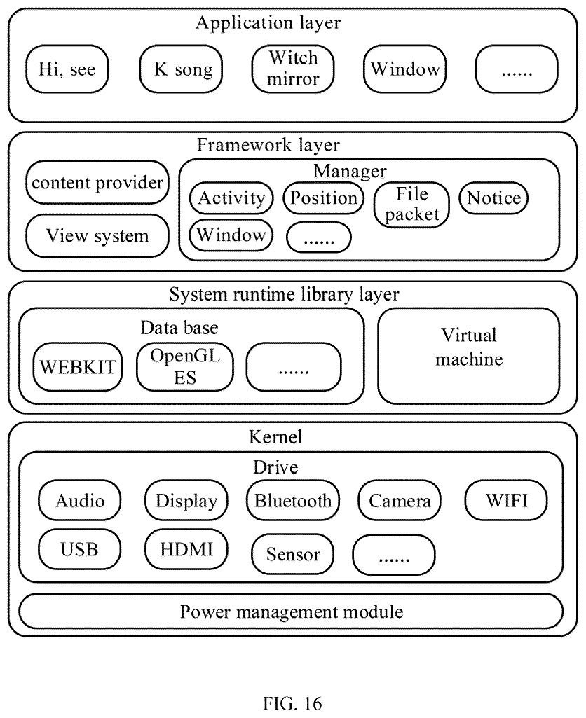

FIG. 16 is a software configuration schematic diagram of a display apparatus according to embodiments of the present application. As shown in FIG. 16, the system is divided into four layers, from top to bottom which are the application layer, application framework layer (referred to as “framework layer”), Android runtime and system library layer (referred to as “system runtime library layer”), and kernel layer. The kernel layer contains at least one of the following drivers: audio driver, display driver, Bluetooth driver, camera driver, WIFI driver, universal serial bus (USB) driver, high definition multimedia interface (HDMI) driver, sensor driver (such as fingerprint sensor, temperature sensor, pressure sensor, etc.), or power supply driver etc.

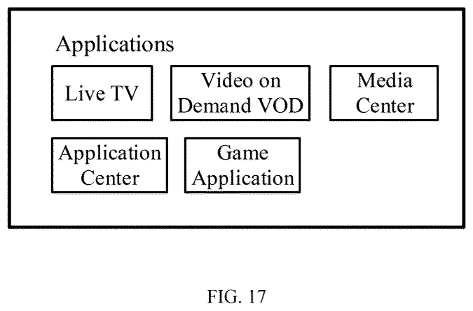

FIG. 17 is a schematic diagram of displaying an icon control interface of an application in a display apparatus according to embodiments of the present application. As shown in FIG. 17, the application layer contains at least one application that can be display as a corresponding icon control on the display, such as: a live TV application icon control, a video on demand application icon control, a media center application icon control, an application center icon control, a game application icon control, etc. The live TV application can provide live TV through different sources. The video on demand application can provide videos from different storage sources. Unlike the live TV application, the video on demand offers the display of video from certain storage sources. The media center application can provide various applications for multimedia content playback. The application center can provide storage for various applications.

For example, the partition backlight processing module of the liquid crystal display (LCD) panel enhances the brightness and color contrast of the image displayed by the LCD and improves the display effect of the image quality by using regional light control technology and increasing the peak brightness of local partitions. In the related art, the image processing unit in the display apparatus processes the to-be-played video to obtain backlight values of all partitions corresponding to each frame of the image that is to be played. The backlight processing module adjusts a backlight peak brightness by using a dynamic backlight modulation curve based on the backlight values of all partitions. In the process of dynamic backlight control, in order to ensure the effect of each frame of image displayed in the video, the image processing unit needs to send the backlight values of all partitions to the backlight processing module within a time limit, such as 8.33 ms of one video frame, thereby enabling the backlight processing module to perform dynamic backlight control in a timely manner to control the brightness display of partition backlights.

However, when the backlight module of the display apparatus has a large number of partitions, due to the bandwidth limitation of transmission between the image processing unit and the backlight processing module, the backlight processing module cannot timely receive the backlight values of all partitions within a time limit, causing that the backlight processing module cannot timely perform dynamical backlight control on the backlight values of all partitions in the backlight module, which affects the display effect of the image.

In order to solve the problem in related art that the backlight processing module cannot accurately perform dynamic backlight control since the backlight processing module cannot timely receive the backlight values of all partitions within the time limit, another driving method for a display apparatus is provided by the present application. All partitions in the backlight module are divided into two or more local backlight regions, and multiple backlight value processing units are set in the controller of the display apparatus according to the number of local backlight regions, so that each backlight value processing unit corresponds to a local backlight region. After obtaining the backlight values of all partitions, the image processing unit groups the backlight values of all partitions according to the positions of the partitions corresponding to the local backlight regions each to obtain multiple backlight value arrays, and sends each backlight value array to the corresponding backlight value processing unit, and sets the mean value of each backlight value array to be synchronized between all backlight value processing units, so that each backlight value processing unit performs dynamic backlight control based on the overall mean value, which not only reduces the number of partition backlight values sent by the image processing unit to the backlight processing module, but also ensures the accuracy of dynamic backlight control, improves the peak brightness of the display image, and improves the display effect of the image.

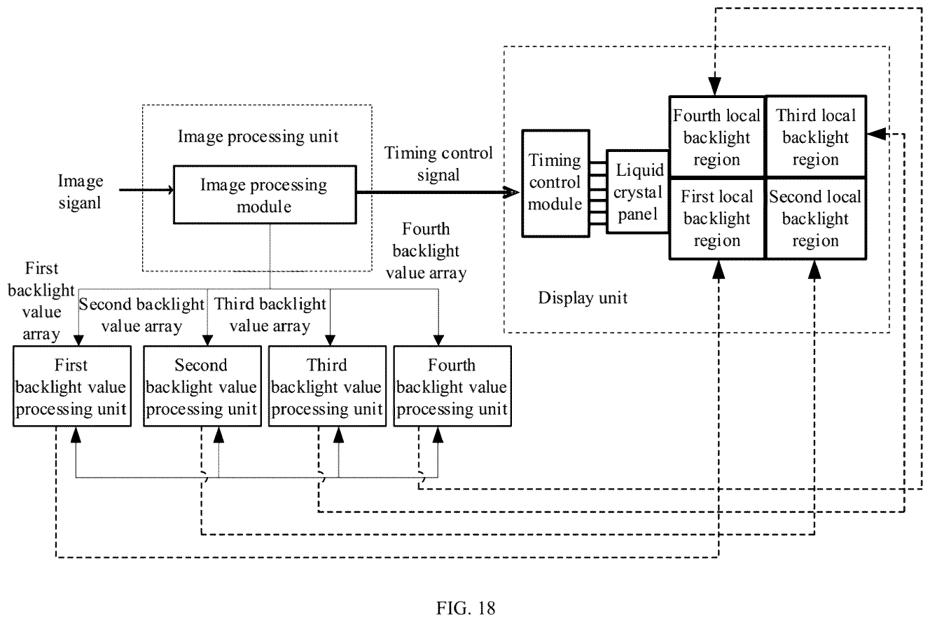

A display apparatus according to embodiments of the present application includes a controller and a display unit. The controller includes an image processing unit and a plurality of backlight value processing units. FIG. 18 is a second structural schematic diagram of a display apparatus according to embodiments of the present application. As shown in FIG. 18, there are a total of four backlight value processing units. Specifically, the image processing unit includes an image processing module, which is a functional unit in the system chip of the display apparatus and is used for image processing of image signals. The image processing module obtains backlight values of all partitions corresponding to each frame of image that is to displayed by using a pre-stored backlight light diffusion model and a partition backlight value extraction algorithm.

Specifically, in the display apparatus according to embodiments of the present application, each backlight value processing unit includes a driving module, and each backlight value processing unit is a microcontroller. The display unit contains a liquid crystal panel and a plurality of local backlight assemblies and is used for displaying an image according to the backlight values sent by all backlight value processing units. The display unit also includes a timing control module, which is used to receive the timing control signal sent by the image processing unit to control the display process of the image frames. In the embodiments of the present application, the image processing unit stores a corresponding relationship between all backlight value processing units and all local backlight assemblies.

Exemplarily, the image processing unit is communicated with each of the backlight value processing units by using a serial peripheral interface bus, and each of the backlight value processing units is communicated with each of the other backlight value processing units by using a serial peripheral interface bus. In the embodiments of the present application, the image processing unit is communicated with each of the backlight value processing units by using the serial peripheral interface bus, so that the image processing unit can simultaneously send the backlight value arrays corresponding to the local backlight regions to the corresponding backlight value processing units. Each of the backlight value processing units is communicated with each of the other backlight value processing units by using a serial peripheral interface bus, so that all backlight value processing units can simultaneously share and synchronize local backlight values, which avoids delays in displaying image frames due to data unsynchronized data transmission.

In the embodiments of the present application, each backlight value processing unit calculates a mean value of all backlight values based on the backlight values of all partitions contained in the backlight value array received, sends the calculated local average value to all other backlight value processing units, and receives local average values each sent by all other backlight value processing units. Each backlight value processing unit calculates the average value based on all the local average values received and the local average value corresponding to the received backlight value array, and determines a target backlight gain parameter based on the calculated target backlight value. Each backlight value processing unit generates a PWM driving signal based on its target backlight gain parameter, and sends its PWM driving signal to the corresponding driving module, so that the driving module controls display brightnesses of all light-emitting diodes in the corresponding local backlight region according to the PWM driving signal.

The technical solution of the present application will be described in detail below with specific examples. The following specific embodiments can be combined with each other, and the same or similar concepts or processes may not be repeated in some embodiments.

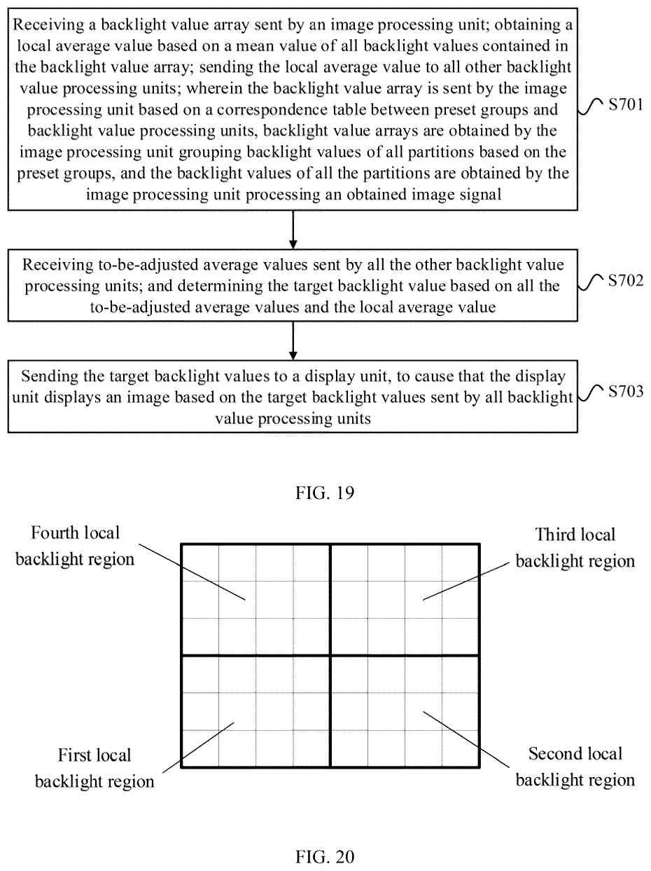

FIG. 19 is a third flowchart of a driving method for a display apparatus according to embodiments of the present application. The execution subject of the embodiment may be the backlight value processing unit in the controller in the embodiment shown in FIG. 18. As shown in FIG. 19, the method includes the following.

S701: receiving a backlight value array sent by an image processing unit; obtaining a local average value based on a mean value of all backlight values contained in the backlight value array; sending the local average value to all other backlight value processing units; wherein the backlight value array is sent by the image processing unit based on a correspondence table between preset groups and backlight value processing units, backlight value arrays are obtained by the image processing unit grouping backlight values of all partitions based on the preset groups, and the backlight values of all the partitions are obtained by the image processing unit processing an obtained image signal.

In the embodiments of the present application, the image processing unit includes an image processing module. A backlight optical model storage unit is pre-stored in the image processing module. The backlight optical model storage unit can be used to obtain the image signal of the to-be-displayed image based on the backlight values of all partitions. For example, the image processing unit performs image gray scale partition statistics on the obtained image signal to obtain the backlight values of all partitions in the backlight module. The pre-stored backlight optical model is the light diffusion model. Based on backlight values corresponding to different position partitions and light diffusion models corresponding to different position partitions, the independent lighting function of each partition is realized, that is, the pixel brightness values of the to-be-displayed images corresponding to all partitions are obtained.

In the embodiments of the present application, the backlight module includes a total of M*N partitions, where M and N are respectively the position information of all partitions contained in the backlight module. Exemplarily, FIG. 20 is a schematic diagram of displaying partition backlight values of a backlight module according to embodiments of the present application. As shown in FIG. 20, the backlight module provided by the embodiments of the present application contains 6 rows and 8 columns of partitions. The serial number of each partition can be determined according to the row number and column number of each partition. Exemplarily, the backlight value corresponding each partition is 0.

In the embodiments of the present application, all partitions in the backlight module contained in the display unit are divided into two or more local backlight regions. Exemplarily, as shown in FIG. 20, all partitions in the backlight module are divided into 4 local backlight regions based on preset groups, which are a first local backlight region, a second local backlight region, a third local backlight region, and a fourth local backlight region. As shown in FIG. 18, in the controller of the display apparatus, 4 backlight value processing units, i.e., a first backlight value processing unit, a second backlight value processing unit, a third backlight value processing unit and a fourth backlight value processing unit, are provided. The first backlight value processing unit, the second backlight value processing unit, the third backlight value processing unit and the fourth backlight value processing unit correspond one-to-one with the first local backlight region, the second local backlight region, the third local backlight region and the fourth local backlight region.

In the embodiments of the present application, after the image processing unit obtains the backlight values of all partitions, the image processing unit groups the backlight values of all partitions based on preset groups to obtain backlight value arrays. That is, the backlight values of all partitions are grouped based on the positions of all partitions included in the first local backlight region, the second local backlight region, the third local backlight region and the fourth local backlight region to obtain a backlight value array corresponding to each local backlight region. The backlight value array is sent to the corresponding backlight value processing unit based on the corresponding relationship table between the backlight value processing units and the local backlight regions. Exemplarily, after the image processing unit groups the backlight values of all partitions based on the preset groups to obtain the backlight value arrays, a first backlight value array, a second backlight value array, a third backlight value array and a fourth backlight value array are obtained. The backlight values contained in the first backlight value array, the second backlight value array, the third backlight value array and the fourth backlight value array correspond to partitions contained in the first local backlight region, the second local backlight region, the third local backlight region and the fourth local backlight region. The image processing unit sends the first backlight value array, the second backlight value array, the third backlight value array and the fourth backlight value array to the first backlight value processing unit, the second backlight value processing unit, the third backlight value processing unit and the fourth backlight value processing unit, respectively.

Exemplarily, after the first backlight value processing unit receives the first backlight value array sent by the image processing unit, the first backlight value processing unit calculates a mean value of all partition backlight values contained in the first backlight value array as a local mean value corresponding to the first local backlight region. The first backlight value processing unit also sends the calculated local average value to the second backlight value processing unit, the third backlight value processing unit and the fourth backlight value processing unit at the same time. While the first backlight value processing unit calculates the mean value of all partition backlight values contained in the first backlight value array, the second backlight value processing unit, the third backlight value processing unit and the fourth backlight value processing unit also calculate their respective local average value.

S702: receiving to-be-adjusted average values sent by all the other backlight value processing units; and determining the target backlight value based on all the to-be-adjusted average values and the local average value.

In the embodiments of the present application, while the first backlight value processing unit sends the calculated local average value simultaneously to the second backlight value processing unit, the third backlight value processing unit and the fourth backlight value processing unit, the first backlight value processing unit also receives local average values respectively sent by the second backlight value processing unit, the third backlight value processing unit and the fourth backlight value processing unit send. That is, a backlight value processing unit not only sends a local average value to all other backlight value processing units, but also receives local average values calculated by all other backlight value processing units, and uses the local average values sent by all other backlight value processing units as the to-be-adjusted average value.

In the embodiments of the present application, based on the local average value calculated by the first backlight value processing unit and the local average values respectively sent by the second backlight value processing unit, the third backlight value processing unit and the fourth backlight value processing unit, a mean value of all local average values is calculated, i.e., an average value of 4 local average values is calculated. Exemplarily, the local average value calculated by the first backlight value processing unit is 128, and the local average values respectively sent by the second backlight value processing unit, the third backlight value processing unit and the fourth backlight value processing unit are 128, 255 and 128 respectively, then the average value of 128, 128, 255 and 128 calculated by the first backlight value processing unit is 159.75. The first backlight value processing unit takes the calculated average value of 159.75 as the target backlight value.

Exemplarily, the first backlight value processing unit can also determine a global average value based on all the to-be-adjusted average values and the mean value of the local average values, then determine a backlight gain parameter corresponding to the global average value, and determine the target backlight value based on the global average value and the backlight gain parameter. Specifically, the local average value calculated by the first backlight value processing unit is 128, and the local average values respectively sent by the second backlight value processing unit, the third backlight value processing unit and the fourth backlight value processing unit are respectively are 128, 255 and 128. The first backlight value processing unit uses the calculated average value 159.75 as the global average value corresponding to the first backlight value processing unit. The first backlight value processing unit may determine the backlight gain parameter corresponding to the global average value based on a preset gain lookup table, or determine the backlight gain parameter corresponding to the global average value based on a backlight gain parameter curve. The target backlight value corresponding to the first backlight value processing unit is determined based on a product of the backlight gain parameter and the global average value. In the embodiments of the present application, by determining the backlight gain parameter corresponding to the global average value, and determining the target backlight value based on the global average value and the backlight gain parameter, dynamic backlight control is achieved, the brightness of the to-be-displayed image is optimized, and the display effect of the image is improved.

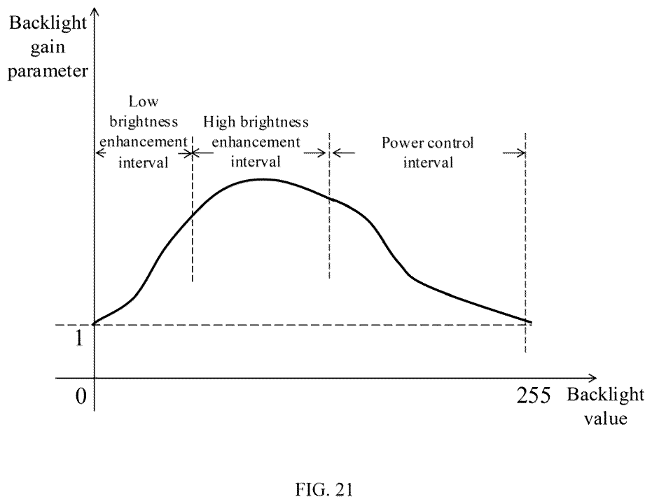

Exemplarily, as shown in FIG. 21, FIG. 21 is a schematic diagram of a backlight gain curve according to embodiments of the present application. Among them, an abscissa represents an average backlight value, and an ordinate represents a backlight gain parameter. Exemplarily, the backlight gain parameter corresponding to the global average value 159.75 of the first backlight value processing unit is determined to be 1.15 based on the backlight gain curve in FIG. 21. Then, the target backlight value corresponding to the first backlight value processing unit is calculated to be 159.75*1.15 which is 183.71.

S703: sending the target backlight values to a display unit, to cause that the display unit displays an image based on the target backlight values sent by all backlight value processing units.

In the embodiments of the present application, the display unit receives the target backlight value sent by the first backlight value processing unit, and controls display brightnesses of the local backlight assemblies respectively corresponding to the backlight value processing units according to the received target backlight values sent by all backlight value processing units.

Exemplarily, each backlight value processing unit includes a driving module, and the display unit includes a liquid crystal display module (such as a liquid crystal panel) and multiple local backlight assemblies. In the process of the display unit displaying the image based on the target backlight values sent by all backlight value processing units, each backlight value processing unit determines a corresponding target local backlight assembly based on a preset correspondence relationship, and at the same time generates a target pulse control signal based on the target backlight value. Specifically, each backlight value processing unit determines the PWM duty cycle of the target pulse control signal based on the target backlight value, and sends the target pulse control signal to the corresponding driving module, so that the driving module controls all the light-emitting diodes contained in the target local backlight assembly based on the target pulse control signal.

Another driving method for a display apparatus is provided by the present application. All partitions in the backlight module are divided into two or more local backlight regions, and multiple backlight value processing modules are set in the controller of the display apparatus according to the number of local backlight regions. After the image processing unit obtains the backlight values of all partitions and groups them to obtain multiple backlight value arrays, the image processing unit sends each backlight value array to the corresponding backlight value processing unit, and sets the mean value of each backlight value array to be synchronized between all backlight value processing units, so that each backlight value processing unit performs dynamic backlight control based on the overall mean value, which not only reduces the number of partition backlight values sent by the image processing unit to the backlight processing module, but also ensures the accuracy of dynamic backlight control, improves the peak brightness of the display image, and improves the display effect of the image.

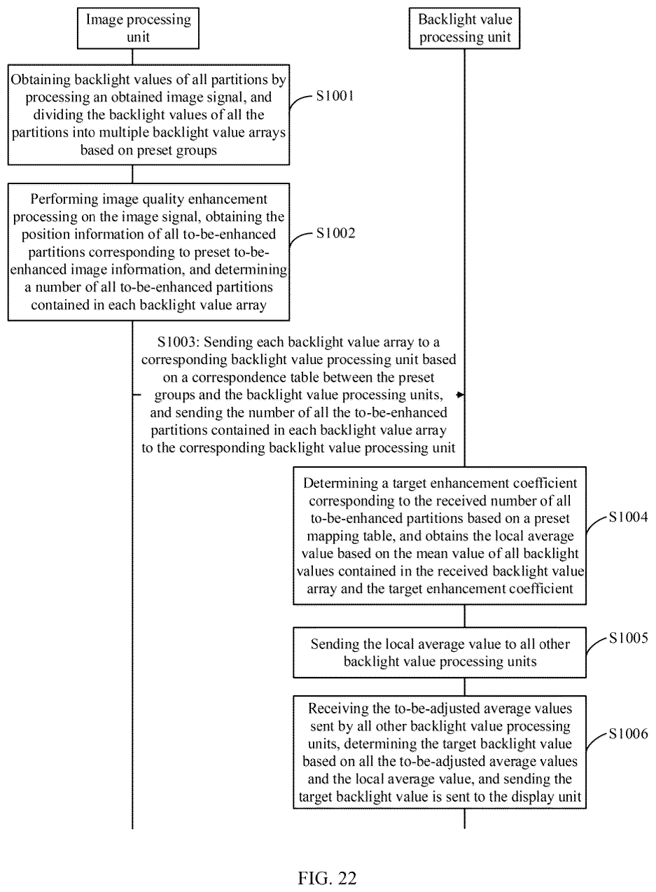

FIG. 22 is a fourth flowchart of a driving method for a display apparatus according to embodiments of the present application. As shown in FIG. 22, based on the driving method for the display apparatus provided by the embodiment of FIG. 19, the calculation of the mean value of each local backlight region is optimized based on the image information that is to be enhanced of the to-be-displayed image. The specific optimization method includes the following steps.

S1001: the image processing unit obtains backlight values of all partitions by processing an obtained image signal, and divides the backlight values of all the partitions into multiple backlight value arrays based on preset groups.

In the embodiments of the present application, the implementation method and effect of the step of S1001 are consistent with that of the image processing unit in S701 in the embodiments of FIG. 19, and will not be described again here.

S1002: the image processing unit performs image quality enhancement processing on the image signal, obtains the position information of all to-be-enhanced partitions corresponding to preset to-be-enhanced image information, and determines a number of all to-be-enhanced partitions contained in each backlight value array.

In the embodiments of the present application, image processing is performed on the image signal to obtain a to-be-displayed image, and image quality enhancement processing is performed on the to-be-displayed image. Specifically, image quality enhancement processing is to purposefully emphasize the overall or local characteristics of the image, make the original unclear image clear or emphasize certain features of interest, expand the differences between the features of different objects in the image, and suppress uninteresting features, which can be used to improve image quality, enrich information, enhance image interpretation and recognition effects, and meet the needs of certain special analyses. In the embodiments of the present application, image quality enhancement processing is performed on the to-be-displayed image, and the colors in the image that need to be enhanced are accurately acted on. Exemplarily, the partition locations corresponding to the colors, that need to be enhanced, of the blue sky, green trees, and close-up human face skin, etc., displayed in the to-be-displayed image are identified. In the embodiments of the present application, after obtaining the position information of all the to-be-enhanced partitions corresponding to the preset to-be-enhanced image information, the number of partitions of all the to-be-enhanced partitions contained in each backlight value array is determined.

S1003: the image processing unit sends each backlight value array to a corresponding backlight value processing unit based on a correspondence table between the preset groups and the backlight value processing units, and sends the number of all the to-be-enhanced partitions contained in each backlight value array to the corresponding backlight value processing unit.

In the embodiments of the present application, the method in S1003 in which the image processing unit sends each backlight value array to a corresponding backlight value processing unit based on a correspondence table between the preset groups and the backlight value processing units is the same as the implementation method and effect of the image processing unit in S701 in the embodiment of FIG. 19, and will not be described again here.

In the embodiments of the present application, while the image processing unit sends each backlight value array to the corresponding backlight value processing unit, it also sends the number of all to-be-enhanced partitions contained in each backlight value array to the corresponding backlight value array, so that each backlight value processing unit calculates the local average value of the backlight values of all contained partitions based on the received backlight value array and the number of to-be-enhanced partitions.

S1004: the backlight value processing unit determines a target enhancement coefficient corresponding to the received number of all to-be-enhanced partitions based on a preset mapping table, and obtains the local average value based on the mean value of all backlight values contained in the received backlight value array and the target enhancement coefficient.

Exemplarily, an enhancement ratio parameter is determined according to the number of all to-be-enhanced partitions and the number of pre-stored local partitions; the target enhancement coefficient corresponding to the enhancement ratio parameter is determined according to the preset mapping table.

In the embodiments of the present application, enhancement ratio parameter value intervals and corresponding enhancement coefficients are set in the preset mapping table. Exemplarily, if a calculated enhancement ratio parameter is located in a first value interval, the enhancement coefficient corresponding to the first value interval is determined as the target enhancement coefficient. Exemplarily, the preset mapping table contains 3 enhancement ratio parameter value intervals. Among them, a first value interval is a value interval greater than or equal to 0 and less than 0.3; a second value interval is a value interval greater than or equal to 0.3 and less than 0.7; and a third value interval is greater than or equal to 0.7, and is less than or equal to 1. The enhancement coefficients corresponding to the first value interval, the second value interval and the third value interval are 0.9, 1.1 and 1.15, respectively.

In the embodiments of the present application, after obtaining the target enhancement coefficient corresponding to the backlight value processing unit, the local average value is obtained based on the product of the mean value of all backlight values contained in the received backlight value array and the target enhancement coefficient. In the embodiments of the present application, on the one hand, by determining the enhancement coefficient corresponding to the enhancement ratio parameter according to the preset mapping table, the proportion of the image information corresponding to the to-be-enhanced partition can be predicted; on the other hand, the local backlight value is adjusted by considering the proportion of the image information corresponding to the to-be-enhanced partition in the local backlight region corresponding to each backlight value processing unit, which improves the accuracy of the calculated backlight value.

S1005: the backlight value processing unit sends the local average value to all other backlight value processing units.

S1006: the to-be-adjusted average values sent by all other backlight value processing units are received, the target backlight value is determined based on all the to-be-adjusted average values and the local average value, and the target backlight value is sent to the display unit.

In the embodiments of the present application, the implementation method and effect of the steps S1005 to S1006 are consistent with that of S701 to S702 in the embodiments of FIG. 19, and will not be described again here.

Another driving method for the display apparatus is provided by the embodiment. The image signal of the to-be-enhanced region is obtained by using the image quality enhancement processing algorithm, the process of calculating the local average value of each local backlight region is optimized based on the target enhancement coefficient, and the local backlight value is adjusted by considering the proportion of the image information corresponding to the to-be-enhanced partition in the local backlight region corresponding to each backlight value processing unit, which improves the accuracy of the calculated backlight value, enhances the image brightness when the proportion of the enhanced region in the display image is higher, and improves the display effect of the image.

Obviously, those skilled in the art can make various changes and modifications to the present application without departing from the spirit and scope of the present application. In this way, if these modifications and variations of the present application fall within the scope of the claims of the present application and equivalent technologies, the present application is also intended to include these modifications and variations.

What is claimed is:

1. A driving method for a display apparatus, comprising: a backlight module and a display panel, wherein the backlight module comprises a plurality of light sources, and the plurality of light sources are divided into a plurality of partitions; wherein
the driving method comprises:
during an image display process, when a display image changes in brightness in a local region, determining a first brightness of the display image; wherein the first brightness is an average brightness of the display image after the display image changes in brightness in the local region;
determining a first driving current corresponding to the first brightness based on the first brightness and a predetermined relationship between brightnesses and driving currents;
adjusting a duty cycle of the first driving current for each partition, which corresponds to other region of the display image except the local region, in the backlight module; and
driving light sources in each partition corresponding to the other region to emit light by using the first driving current with the adjusted duty cycle, to cause that the display image remains unchanged in brightness in the other region.

2. The driving method according to claim 1, wherein the adjusting the duty cycle of the first driving current for each partition, which corresponds to other region of the display image except the local region, in the backlight module, comprises:
determining a second brightness of the display image and a duty cycle of a second driving current; wherein the second brightness is an average brightness of the display image before the display image changes in brightness in the local region, and the second driving current is a driving current corresponding to the second brightness; and
determining the duty cycle of the first driving current based on the second brightness, the duty cycle of the second driving current, and the first brightness.

3. The driving method according to claim 2, wherein the first driving current is smaller than the second driving current.

4. The driving method according to claim 1, wherein the average brightness of the display image is determined by:
taking an average value of brightnesses of the plurality of partitions in the display image as the average brightness of the display image.

5. The driving method according to claim 4, wherein the duty cycle of the first driving current is determined by using a following formula: D₁=D₂ (L₂/L₁);
wherein, D₁ represents the duty cycle of the first driving current, D₂ represents the duty cycle of the second driving current, L₁ represents the first brightness, and L₂ represents the second brightness.

6. The driving method according to claim 1, further comprising: determining a duty cycle of the first driving current for each partition, which corresponds to the local region, in the backlight module, wherein the determining the duty cycle of the first driving current for each of partitions, which corresponds to the local region, in the backlight module, comprises:
taking a ratio of a brightness of a partial image of the display image corresponding to each partition corresponding to the local region to a maximum brightness as the duty cycle of the first driving current for each partition corresponding to the local region.

7. The driving method according to claim 1, wherein the predetermined relationship between brightnesses and driving currents meets a known relationship curve between driving currents and brightnesses of the display apparatus.

8. The driving method according to claim 1, further comprising:
receiving a backlight value array sent by an image processing unit;
obtaining a local average value based on a mean value of all backlight values contained in the backlight value array;
sending the local average value to all other backlight value processing units; wherein the backlight value array is sent by the image processing unit based on a correspondence table between preset groups and backlight value processing units, backlight value arrays are obtained by the image processing unit grouping backlight values of all partitions based on the preset groups, and the backlight values of all the partitions are obtained by the image processing unit processing an obtained image signal;
receiving to-be-adjusted average values sent by all the other backlight value processing units;
determining target backlight values based on all the to-be-adjusted average values and the local average value; and
sending the target backlight values to a display unit, to cause that the display unit displays an image based on the target backlight values sent by all backlight value processing units.

9. A display apparatus, comprising:
a display panel, configured for image display;
a backlight module, located on a light incident side of the display panel and configured to provide backlight; wherein the backlight module comprises a plurality of light sources, the plurality of light sources are divided into a plurality of partitions, each of the plurality of partitions comprises at least one light source, and the at least one light sources in a same one partition is connected in series; and
backlight value processing units, electrically connected to the plurality of partitions and configured to provide driving signals to the plurality of partitions;
wherein the backlight value processing units are configured to:
during an image display process, when a display image changes in brightness in a local region, determine a first brightness of the display image; wherein the first brightness is an average brightness of the display image after the display image changes in brightness in the local region;
determine a first driving current corresponding to the first brightness based on the first brightness and a predetermined relationship between brightnesses and driving currents;
adjust a duty cycle of the first driving current for each partition, which corresponds to other region of the display image except the local region, in the backlight module; and
drive light sources in each partition to emit light by using the first driving current with the adjusted duty cycle, to cause that the display image remains unchanged in brightness in the other region.

10. The display apparatus according to claim 9, further comprising: a controller and a display unit, the controller comprising an image processing unit and the backlight value processing units;
wherein the image processing unit is configured to:
obtain backlight values of all partitions by processing an obtained image signal, divide the backlight values of all the partitions into a plurality of backlight value arrays based on preset groups, and send each of the plurality of backlight value arrays to a backlight value processing unit corresponding to the backlight value array based on a correspondence table between the preset groups and the backlight value processing units;
each of the backlight value processing units is configured to: obtain a local average value based on a mean value of all backlight values contained in the received backlight value array, send the local average value to all other backlight value processing units, receive to-be-adjusted average values sent by all the other backlight value processing units, determine a target backlight value based on all the to-be-adjusted average values and the local average value, and send the target backlight value to a display unit; and
the display unit is configured to display an image based on target backlight values sent by all the backlight value processing units.

11. The display apparatus according to claim 10, wherein each of the backlight value processing units comprises a driving module, and the display unit comprises a liquid crystal display module and a plurality of local backlight assemblies, and when sending the target backlight values to the display unit, the backlight value processing unit is configured to:
determine a corresponding target local backlight assembly based on a preset correspondence relationship;
generate a target pulse control signal based on the target backlight value, and send the target pulse control signal to a corresponding driving module, to cause that the driving module controls display brightnesses of all light-emitting diodes contained in the target local backlight assembly based on the target pulse control signal.

12. The display apparatus according to claim 10, wherein after dividing the backlight values of all the partitions into the plurality of backlight value arrays based on the preset groups, the image processing unit is further configured to:
perform image quality enhancement processing on the image signal, obtain position information of all to-be-enhanced partitions corresponding to preset to-be-enhanced image information, and determine a number of all to-be-enhanced partitions contained in each backlight value array; and
send the number of all to-be-enhanced partitions contained in each backlight value array to the corresponding backlight value processing unit;
wherein when obtaining a local average value based on a mean value of all backlight values contained in the received backlight value array, the backlight value processing unit is configured to:
determine a target enhancement coefficient corresponding to the received number of all to-be-enhanced partitions based on a preset mapping table, and obtain the local average value based on the mean value of all backlight values contained in the received backlight value array and the target enhancement coefficient.

13. The display apparatus according to claim 12, wherein when determining the target enhancement coefficient corresponding to the received number of all to-be-enhanced partitions based on the preset mapping table, the backlight value processing unit is configured to:
determine an enhancement ratio parameter based on the number of all the to-be-enhanced partitions and a number of pre-stored local partitions; and
determine a target enhancement coefficient corresponding to the enhancement ratio parameter based on the preset mapping table.

14. The display apparatus according to claim 10, wherein when determining the target backlight value based on all the to-be-adjusted average values and the local average value, the backlight value processing unit is configured to:
determine a global average value based on all the to-be-adjusted average values and a mean value of local average values;
determine a backlight gain parameter corresponding to the global average value; and
determine the target backlight value based on the global average value and the backlight gain parameter.

15. The display apparatus according to claim 14, wherein when determining the backlight gain parameter corresponding to the global average value, the backlight value processing unit is configured to:
determine the backlight gain parameter corresponding to the global average value based on a preset gain lookup table.

16. The display apparatus according to claim 14, wherein when determining the backlight gain parameter corresponding to the global average value, the backlight value processing unit is configured to:
determine the backlight gain parameter corresponding to the global average value based on a backlight gain parameter curve.

17. The display apparatus according to claim 10, wherein the image processing unit is communicated with each of the backlight value processing units by using a serial peripheral interface bus, and each of the backlight value processing units is communicated with each of the other backlight value processing units by using a serial peripheral interface bus.
